(19) United States
(12) Patent Application Publication
(10) Pub. No.: US 2005/0114775 A1
(43) Pub. Date: May 26, 2005

(54) User assisting program product, method, and information processing apparatus

(75) Inventors: Takashi Inui, Yokohama-shi (JP); Hidetoshi Mori, Yokohama-shi (JP); Mizuho Tadokoro, Yamato-shi (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/976,209

(22) Filed: Oct. 28, 2004

(30) Foreign Application Priority Data
Oct. 28, 2003 (JP) 2003-367380

(51) Int. Cl. G06F 17/00; G06F 9/00; G06F 3/00

(52) U.S. Cl. 715/707; 715/705

(57) ABSTRACT

An assistance program which assists a user of an information processing apparatus in operating the apparatus causes the information processing apparatus to function as a detection mechanism for detecting whether or not a setting of a set of input/output devices has been changed within a reference time period. The assistance program further causes the information processing apparatus to function as a notification mechanism for conditionally notifying the user that the user can change the setting of the input/output devices. One such notification condition exists where no setting of the input/output devices has changed in the reference period.

### BACKGROUND OF THE INVENTION

The present invention relates to an assistance program product distributed as a recording medium, a method of deploying computing infrastructure, and an information processing apparatus and, in particular, to an assistance program, a recording medium, and an information processing apparatus that notifies a user of information concerning operations of the information processing apparatus.

Recent information processing apparatuses such as personal computers have been equipped with various input and output devices and functions and have become increasingly convenient. These input/output devices can be made more convenient by setting various parameters. This may be little known to users, however.

In consideration of this, conventional operations systems include a database for online-help messages and users can search the database to readily obtain information about settings of input/output devices, for example. Furthermore, a technology has been known in which after an application has received no input from a user for a predetermined period of time, the user is considered as being unfamiliar with the operation of the application program and a search panel for searching an operating instruction for an application program is displayed.

In order to improve usability, technologies have been proposed for changing instructions for operating a device or placing a limitation on messages presented to a user according to the user or other circumstances. For example, a technology has been proposed (in Patent Document 1) for changing a command input the device by a user to a different command according to surroundings or circumstances of users. Another technology has been proposed (in patent document 2) that determines a user's familiarity with a device on the basis of the length of time in which the user has been using the device and adjusts the number of error messages to be presented to the user according to the familiarity.

Patent Document 1

Published Unexamined Patent Application No. 6-266403

Patent Document 2

Published Unexamined Patent Application No. 2002-342049

Problems to be Solved by the Invention

However, there may be a case where a user does not know the fact itself that he or she is allowed to change settings on an input/output device. In such a case, even though an online-help message search panel is displayed, the user does not refer to an online help message unless he or she encounters a difficulty in operating the device. Therefore, capabilities of the input/output device may not be fully used. Neither of the technologies disclosed in patent documents 1 and 2 can notify a user that settings on an input/output device are allowed to be changed.

Therefore, a purpose of the present invention is to provide an assistance program, storage medium, and information processing apparatus that can solve the problem. The purpose is achieved by the combination of features set forth in the independent claims herein. The dependent claims define preferable, specific embodiments of the present invention.

### SUMMARY OF THE INVENTION

To solve the problem described above, there is provided according to the first embodiment of the present invention an assistance program recording medium on which the assistance program is recorded, and an information processing apparatus that functions according to the assistance program for assisting a user to operate the information processing apparatus, wherein the assistance program causes the information processing apparatus to function as: detection means for detecting whether or not a setting of an input/output device has been changed in a predetermined reference period; and notification means for notifying the user that the setting of the input/output device is allowed to be changed, if the setting of the input/output device has not been changed in the predetermined reference period.

Implementations of the invention include providing any of the various aspects of the invention to a customer. Accordingly, implementations of the invention include implementations as a service method in which any of the apparatus and program product aspects, alone or in combination, are deployed at a customer site to address the above described challenges.

The above-described summary of the invention does not list all essential features of the present invention and sub-combinations of these features are also covered by the present invention.

The present invention allows the capabilities of an information processing apparatus to be fully used to enhance the convenience of the information processing apparatus.

### BRIEF DESCRIPTION OF THE DRAWINGS

Some of the purposes of the invention having been stated, others will appear as the description proceeds, when taken in connection with the accompanying drawings, in which:

FIG. 1 shows a general view of an information processing apparatus 10;

FIG. 2 shows a functional block diagram of the information processing apparatus 10;

FIG. 3 shows a process for an assistance program to cause the information processing apparatus 10 to detect a change of setting of an input/output device;

FIG. 4 shows in detail a process performed at S350 in FIG. 3; and

FIG. 5 shows a process of the assistance program to cause the information processing apparatus 10 to detect the user of an input/output device.

### DETAILED DESCRIPTION OF THE ILLUSTRATIVE EMBODIMENTS

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention. Furthermore, not all of the combinations of features described with respect to any embodiment are essential for the solution according to the present invention.

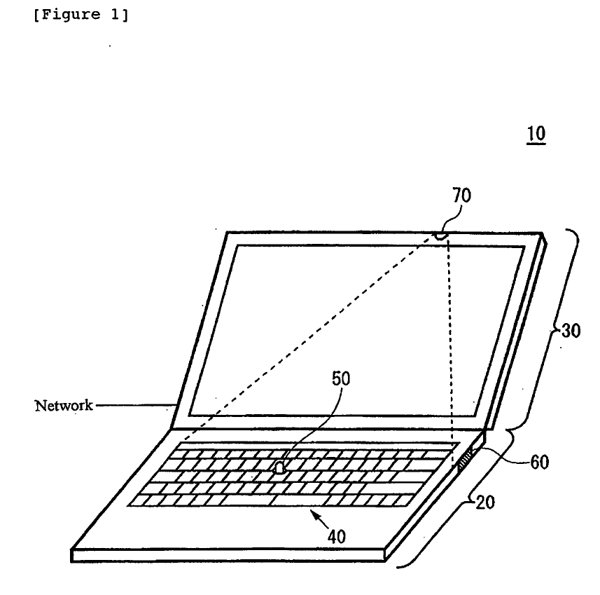

Referring now more particularly to the accompanying drawings, in which like numerals indicate like elements or steps throughout the several views, FIG. 1 shows a general view of an information processing apparatus 10. The information processing apparatus 10, which may be a portable information and communication terminal such as a notebook personal computer, includes an input section 20 for receiving an input by a user and a display section 30 that can be opened and closed with respect to the input section 20 and presents information to the user at its open position. The input section includes a keyboard 40, a pointing device 50, and infrared communication device 60. The display section 30 includes a keyboard illumination light 70 and, when closed, veils the input section 20 from the user.

If settings of an input/output device such as the keyboard 40, the pointing device 50, the infrared communication device 60, or the keyboard illumination light 70 have not been changed for a predetermined reference period, the information processing apparatus 10 notifies the user that the settings of the input/output device are allowed to be changed. If an input/output device has not been used in the predetermined period, the information processing apparatus 10 notifies the user that the input/output device is available. The purpose of this is to allow the capabilities of an information processing apparatus 10 to be fully used and enhance the convenience for the user.

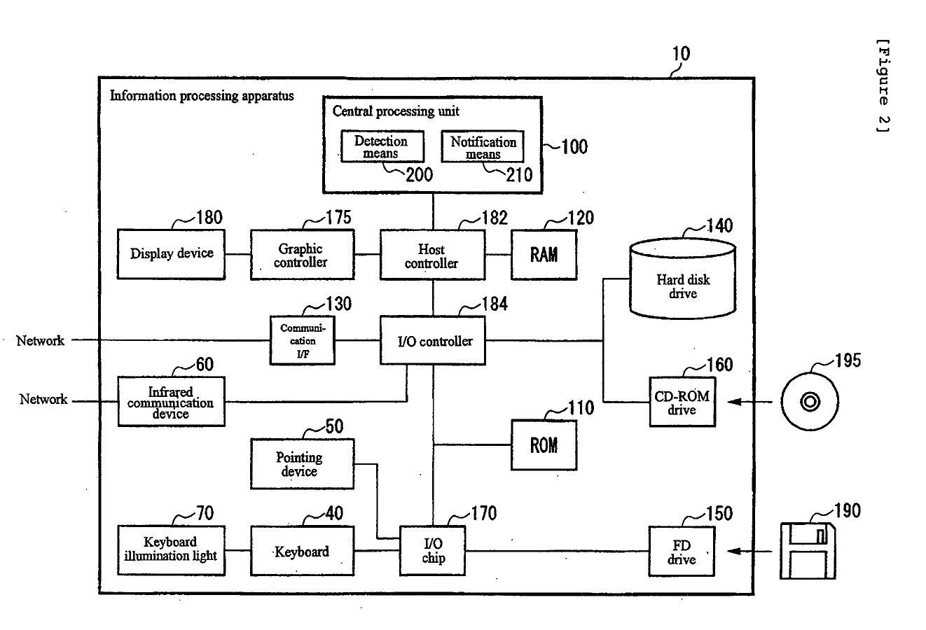

FIG. 2 shows a functional block diagram of an information processing apparatus 10. The information processing apparatus 10 has a CPU section including a central processing unit 100, a RAM 120, a graphics controller 175, and a display device 180, which are interconnected through a host controller 182, an input/output section including a communication interface 130, a hard disk drive 140, an infrared communication device 60, and a CD-ROM drive 160, which are connected to the host controller 182 through an input/output controller 184, and a legacy input/output section including a ROM 110, a flexible disk drive 150, a keyboard 40, a pointing device 50, a keyboard illumination light 70, and an input/output chip 170, which are connected to the input/output controller 184.

The keyboard 40 has a number of keys that are depressed by a user. The information processing apparatus 10 has the function of setting, as specified by a user, a response speed that represents the time from a depression of a key on the keyboard 40 to the time at which the key input is recognized. The pointing device 50 moves a pointer displayed on the display screen in the display section 30 when touched or depressed by a user. The information processing apparatus 10 has the function of setting, as specified by a user, the sensitivity representing the distance the pointer moves when the pointing device 50 is moved by a given amount by a user.

The infrared communication device 60 is an input/output device through which the information processing apparatus 10 communicates with another information processing apparatus by infrared rays. The keyboard illumination light 70 illuminates the keyboard 40 of the information processing apparatus 10 so that a user can read the keytops in an unlit place in the night.

The central processing unit 100 has detection means 200 and notification means 210. In particular, an assistance program installed and executed in the information processing apparatus 10 causes the central processing unit 100 of the information processing apparatus 10 to function as the detection means 200 and the notification means 210. The detection means 200 detects whether or not a setting of an input/output device of the information processing apparatus 10 has been changed within a predetermined reference period of time. If no settings of an input/output device has changed in the reference period, the notification means 210 notifies the user that the use can change the settings of the input/output device.

The detection means 200 may detect whether a setting of a power management function that controls the power supply of the information processing apparatus 10 has been changed in a predetermined reference period of time. In that case, if the setting of the power management function has not been changed within the reference period, the notification means 210 notifies the user that the user can change the settings of the power management function.

The host controller 182 connects the RAM 120 with the central processing unit 100 and the graphic controller 175, which access the RAM 120 at a high transfer rate. The central processing unit 100 operates according to the assistance program stored in the ROM 110 and the RAM 120 to control the components of the information processing apparatus 10. The graphic controller 175 obtains an image data generated by the central processing unit 100 or other means on a frame buffer provided in the RAM 120 and displays it on the display device 180. Alternatively, the graphic controller 175 may contain within it a frame buffer for storing image data generated by the central processing unit 100 or other means.

The input/output controller 184 connects the host controller 182 with relatively fast input/output devices such as the communication interface 130, the hard disk drive 140, and CD-ROM drive 160. The communication interface 130 communicates with an external device through a network. The hard disk drive 140 stores the assistance program and data used by the information processing apparatus 10. The CD-ROM drive 160 reads the assistance program or data from a CD-ROM 195 and provides it to the input/output chip 170 through the RAM 120.

Also connected to the input/output controller 184 are relatively low speed input/output devices such as the ROM 110, the flexible disk drive 150, and the input/output chip 170. The ROM 110 stores a boot program to be executed by the central processing unit 100 on activation of the information processing apparatus 10 and programs dependent on the hardware of the information processing apparatus 10. The flexible disk drive 150 reads the assistance program or data from a flexible disk 190 and provides it to the input/output chip 170 through the RAM 120. The input/output chip 170 provides connection to a flexible disk 190, or various input/outputs devices through a parallel port, a serial port, a keyboard port, mouse port, or the like.

The assistance program to be provided to the information processing apparatus 10 is stored in a recording medium such as a flexible disk 190, CD-ROM 195, or IC card and provided by a user to the information processing apparatus 10. The assistance program is read from a recording medium through the input/output chip 170 and/or the input/output controller 184 and installed and executed in the information processing apparatus 10. The assistance program installed and executed in the information processing apparatus 10 includes a detection module and a notification module.

The assistance program or modules mentioned above may be stored in an external storage medium. The external storage medium may be a flexible disk 190 or a CD-ROM 195, or an optical recording medium such as a DVD or PD, a magneto-optical recording medium such as an MD, a tape medium, or semiconductor memory such as an IC card. The assistance program may be stored in a storage device used as the storage medium, such as a hard disk or RAM provided in a server system on a private communication network or the Internet and provided to the information processing apparatus 10 over the network.

The information processing apparatus 10 also has the capability of being placed in different operation modes with different power consumptions. In particular, the information processing apparatus 10 has normal operation mode in which the central processing unit 100 executes instructions and processes information. The information processing apparatus 10 also has hibernation mode which consumes lower power than the normal operation mode and in which the central processing unit 100 is stopped and an execution state in which the central processing unit 100 was executing an instruction is stored in an auxiliary storage such as the hard disk drive 140. Furthermore, the information processing apparatus 10 has suspend mode in which power consumption is lower than in the normal operation mode but higher than in the hibernation mode, and the central processing unit 100 is stopped and the operation status of the central processing unit 100 is stored in the main memory such as the RAM 120.

The time required for returning from the hibernation mode to normal operation mode is shorter than the time required for returning from the power-off state to the normal operation mode. Moreover, the time required for returning from the suspend mode to the normal operation mode is shorter than the time required for returning from the hibernation mode to the normal operation mode. If a user wants to stop using the information processing apparatus 10 for a short time, placing the information processing apparatus 10 in the suspend mode or the hibernation mode is more convenient than powering off the information processing apparatus 10 because it can return to normal operation quicker.

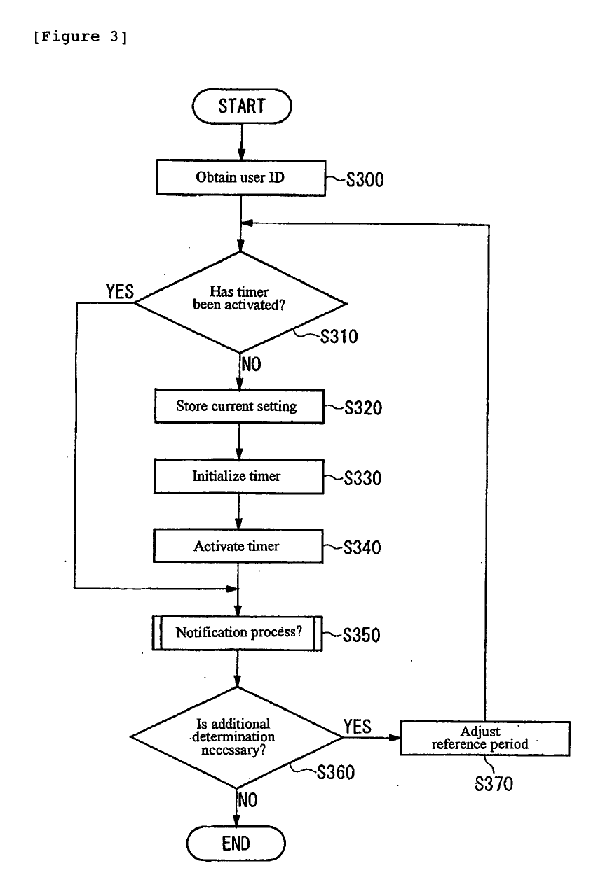

FIG. 3 shows a process for the assistance program to cause the information processing apparatus 10 to detect a change of a setting of an input/output device. When activated in response to a direction from a user, the information processing apparatus 10 performs the following process for that particular input/output device or power management function. In particular, the following process is performed individually for a setting of response time of the keyboard 40, setting of sensitivity of the pointing device 50, the setting of enabling or disabling the hibernation mode, and the setting of the operation mode in which the information processing apparatus 10 is to be placed when the display section 20 is closed during normal operation mode.

The information processing apparatus 10 obtains an ID, which is the identification of a user (S300). For example, it obtains the ID of the user logging in the operating system of the information processing apparatus 10. Then, the information processing apparatus 10 determines whether a timer used for determining whether a reference period of time has elapsed has been set for the user and activated (S310). If the timer has been activated (S310: YES), the information processing apparatus 10 proceeds to S350.

On the other hand, if the timer has not been activated (S310: NO), the information processing apparatus 10 saves the current setting of the input/output device or power management function in a non-volatile recording medium, for example the hard disk drive 140 (S320). Then, in order to set the timer for this user, the information processing apparatus 10 sets the timer to an appropriate value that allows the expiration of the reference period to be detected (S330). The information processing apparatus 10 then activates the timer (S340). Subsequently, if the setting of the input/output device or power management function is not changed within the reference period of time, the detection means 200 and the notification means 210 notify the user of this (S350). The notification process will be detailed later.

Preferably, the information processing apparatus 10 sets the timer used for determination whether the reference period of time has expired for each combination of an input/output device and a user. That is, a timer for measuring the period of time during which user A has not changed the sensitivity of the pointing device 50 differs from a timer for measuring the period of time during which user B has not changed the sensitivity of the pointing device 50. Preferably, when the information processing apparatus 10 is reactivated, the information processing apparatus 10 uses the value of the timer it was using before reactivated. That is, the information processing apparatus 10 uses the cumulative period during which a user has not changed a setting to determine whether the reference period of time has elapsed. Thus, even if a longer reference period is set than the a period during which the information processing apparatus 10 typically continues to operate, for example one year, proper determination as to whether the reference period has elapsed can be made.

Then, if there is necessity to make determination one more time as to whether a setting of the input/output device or power management function has been changed (S360: YES), the information processing apparatus 10 adjusts the reference period (S370) and then returns control to S310. For example, the information processing apparatus 10 adjusts the reference period appropriately so that the user will be notified at regular time intervals that the settings of an input/output device or power management function are variable, if a setting of the input/output device was hot changed during the reference period of time and yet the user has not change the setting. Then the information processing apparatus 10 returns control to S310.

On the other hand, if there is no necessity to make determination one more time as to whether the input/output device or power management function has been changed (S360: NO), the process will ends. For example, if the user changes a setting of an input/output device and provides an input indicating that the user does not want another notification, the information processing apparatus 10 will end the process and will not notify the user that settings of an input/output device are variable.

If the operating system does not permit a user to change a setting of an input/output device, the process described above is not required to be performed. If the permission is set for each individual input/output device, the determination whether or not the process described above should be performed is preferably made for each input/output device.

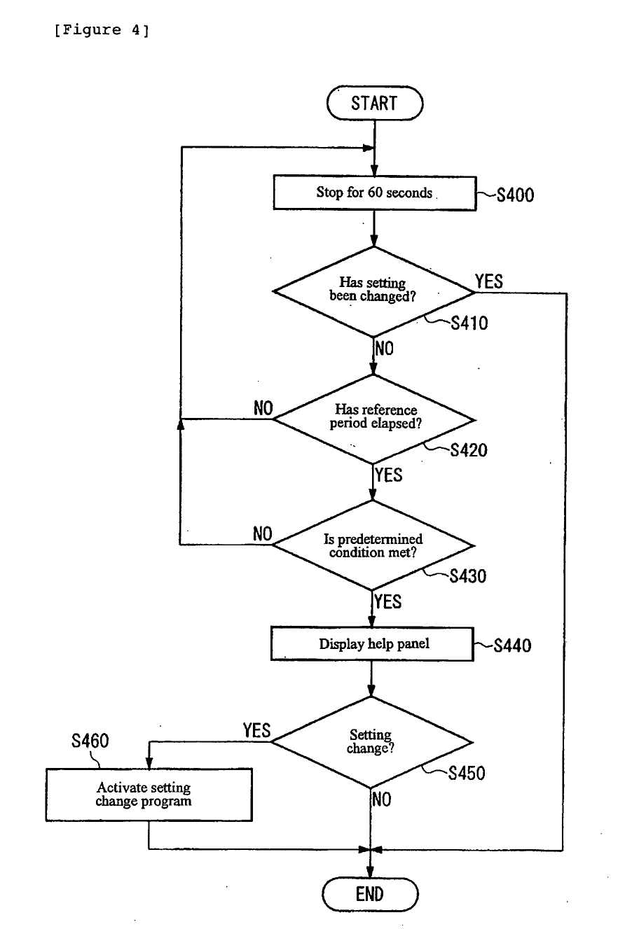

FIG. 4 shows in detail the process performed at S350 in FIG. 3. The information processing apparatus 10 stops for 60 seconds the process for detecting whether a setting of the output/input device of power management function has been changed in the reference period (S400). In other words, the information processing apparatus 10 detects approximately every 60 seconds whether or not a setting of the input/output device or power management function has been change in the reference period. Preferably, the detection is made at regular intervals long enough in order to prevent an increase in power consumption in the information processing apparatus 10, or not to inhibit processes performed by the central processing unit 100. Moreover, the information processing apparatus 10 may determine the interval on the basis of the remaining power of a battery when the information processing apparatus 10 is powered from the battery, or on the basis of the usage ratio of the central processing unit 100.

The detection means 200 detects whether or not a setting of the input/output device or power management function has been changed (S410). For example, the detection means 200 may check whether or not the current setting differs from the setting stored at S320 in FIG. 3 to determine whether or not the setting has been changed. Alternatively, the detection means 200 may compare the current setting with the factory default setting of the information processing apparatus 10 and, if they differ from each other, may determine that the setting has been changed. Furthermore, each time a user changes a setting, the detection means 200 may record the change as a history on a non-volatile recording medium and may refer to the history to detect whether or not the setting has been changed.

If a setting has been changed (S410: YES), the detection means 200 will end the process. The detection means 200 may allow a user to input an indication whether or not the user want subsequent notification if the reference period has elapsed without a setting change. Based on this input, the information processing apparatus 10 makes determination at step S360 in FIG. 3. On the other hand, if a setting has not been changed (S410: NO), the detection means 200 determines whether or not the reference period has elapsed (S420). This means that the detection means 200 determines whether a setting of the input/output device or power management function has been changed in the reference period. If the reference period has not elapsed (S420: NO), the information processing apparatus 10 returns to S400.

The reference period may vary depending on input/output devices and power management function. In other words, the detection means 200 may determine whether or not a setting of each individual input/output device or power management function has been changed in the reference period that is specified for that input/output device or power management function. The reference period can be adapted for the characteristic of a device, such as setting a shorter reference period for a function that does not require frequent setting changes whereas setting a longer reference period of time for a function that does not require frequent setting changes.

If the reference period of time has elapsed, that is, a setting of the input/output device or power management function has not been changed in the reference period (S420: YES), the notification means 210 determines whether or not a predetermined condition for notifying the user of the expiration is met (S430). If the condition is met (S430: YES), the notification means 210 displays a help panel for notifying that settings of the input/output device or power management function are variable (S440). The notification means 210 prompts the user to input an indication whether or not the user wants to change the setting. If the user inputs an indication for changing the setting (S450: YES), the notification means 210 activates a setting change program, which accepts the change of setting of the input/output device from the user (S460).

Examples in which the process described above is applied to input/output devices and a power management function will be described below.

(1) Response Speed of Keys on Keyboard 40

The detection means 200 detects whether or not the response speed of any of the keys of the keyboard 40 has been changed in a reference period (S420). If not changed (S420: YES), the notification means 210 determines that detection of an mistakenly typed key on the keyboard 40 meets a predetermined condition (S430: YES) and notifies the user that the user can change the response speed of each individual key on the keyboard 40 (S440).

For example, the notification means 210 may determine that a key has been mistakenly depressed if the depression opens a window of an application program and the window is closed within a predetermined period of time after the window is opened. In particular, if an online-help window is opened as a result of depression of the “F1” key and then closed within a predetermined time, the notification means 210 determines that the “F1” key has been mistakenly depressed. In that case, the user can change the response speed of the “F1” key so that the information processing apparatus 10 becomes slow to respond depression of the “F1” key, and thus the usability of the information processing apparatus 10 is improved.

Alternatively, the notification means 210 may determine the condition is met if one key on the keyboard 40 is depressed and another key adjacent to that key is depressed within a predetermined period of time. For example, the notification means may determine that the condition is met if one key and the other key are depressed nearly simultaneously. In particular, if an “ESC” key and the “F1” key are depressed nearly simultaneously, the notification means 210 may determine that one of the “ESC” key and “F1” key has been mistakenly depressed. In that case, the user can change the response speed of any of those keys so that the information processing apparatus 10 becomes slow to depression of that key, thus the usability of the information processing apparatus 10 is improved.

(2) Sensitivity of Pointing Device 50

The detection means 200 determines whether or not the sensitivity of a pointing device 50 has changed in a reference period (S420). If it has not been changed (S420: YES) and the pointing device 50 is being used by a user, the notification means 210 determines that a predetermined condition is met (S430: YES). Then, the notification means 210 notifies the user that the sensitivity of the pointing device 50 can be changed (S440). Thus, the notification can be provided to the user at timing suited to the user without displaying needless information while the user is not operating the pointing device 50.

(3) Enabling or Disabling Hibernation Mode

The detection means 200 determines whether or not a setting for enabling or disabling the function of switching to hibernation mode is changed within a reference period of time (S420). If it has not been changed (S420: YES) and the time elapsed between the time at which the information processing apparatus 10 switched from normal operation mode to suspend mode and the time at which it returns to the normal operation mode is longer than predetermined time, the notification means 210 determines that a predetermined condition is met (S430: YES). Then, the notification means 210 notifies the user that the function of switching to hibernation mode can be enabled (S440). Thus, notification that the hibernation mode is available can be provided appropriately to the user who are using suspend mode for a long time despite the availability of the hibernation mode.

Alternatively, the notification means 210 may determine that the condition is met (S430: YES) if the frequency at which a user powers off the information processing apparatus 10 is higher than a predetermined frequency. In this case, notification that the hibernation mode is available can be provided to the user who frequently powers off the information processing apparatus despite the availability of the hibernation mode.

(4) Setting Mode to which the Information Processing Apparatus Switches when the Input Section 20 is Closed in Normal Operation Mode

The information processing apparatus 10 can place itself in another operation mode when the input section 20 is covered with the display section 30 in normal operation mode. It would be convenient for the user if the mode to which the information processing apparatus 10 switches is appropriately set, because the user can change operation mode without operating other means such as a button.

The detection means 200 detects whether or not the mode to which the information processing apparatus 10 switches has been changed in a reference period (S420). If it has not been changed (S420: YES) and no mode is set as the mode to which the information processing apparatus 10 is to switch, the notification means 210 determines that a predetermined condition is met (S430: YES). Then, the notification means 210 notifies the user that the operation mode to which the information processing apparatus 10 switches when the input section 20 is covered in normal operation mode can be changed (S440).

As has been described above, the information processing apparatus 10 detects an input/output device or a power management function the setting of which has not been changed by a user within a reference period of time and can notify the user that the user can change the setting. This can prompt the user to make an appropriate setting change to improve convenience to the user. Furthermore, the information processing apparatus 10 notifies the user that a setting is variable, only if a predetermined condition is met. Consequently, notification unnecessary for the user can be avoided from being provided and only the notification that is required for the user can be provided to the user.

The process described above and shown in FIG. 4 can be applied to other examples as well. For example, the detection means 200 may detect whether or not the amount of time that passes a screen saver of the information processing apparatus 10 has been changed in a reference period. Furthermore, the detection means 200 may detect whether or not the processing speed of the central processing unit 100 or the rotation speed of a CD-ROM 160 has been changed within a reference period. Moreover, the detection means 200 may detect whether or not the time period after which some functions of the information processing apparatus 10 are to be turned off to save power has been changed a reference period of time. If any of these settings has not been changed within a reference period of time, the notification means 210 notifies the user that the user can change the setting. Consequently, the user can fully use additional capabilities of the information processing apparatus 10 and thus convenience to the user can be enhanced.

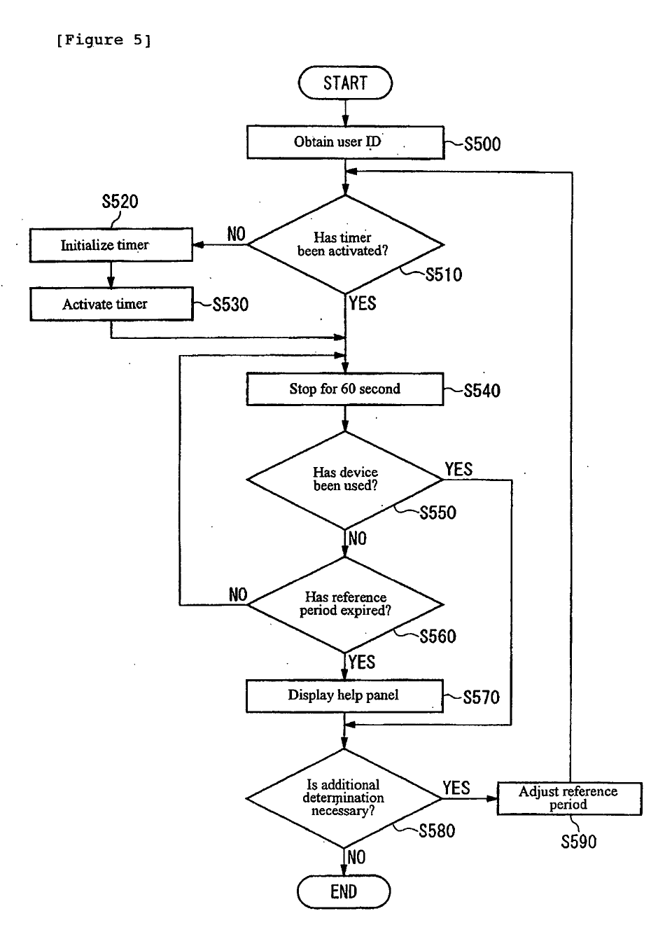

FIG. 5 shows a process for an assistance program to cause the information processing apparatus 10 to detect the use of an input/output device. When activated in response to a command from a user, the information processing apparatus 10 performs the following process separately for the infrared communication device 60 and the keyboard illumination light 70, which are input/output devices. First, the information processing apparatus 10 obtains an ID, identification information, of the user (S500). Then, the information processing apparatus 10 determines whether or not a timer used for determining a reference period has been elapsed has been set for the user and activated (S510). If the timer has been activated (S510: YES), the information processing apparatus 10 proceeds to S540.

On the other hand, if the timer has not been activated (S510: NO), the information processing apparatus 10 sets the timer to an appropriate value that allows the expiration of the reference period of time to be detected so that the timer is associated with the user (S520). Then the information processing apparatus 10 activates the timer (S530). The information processing apparatus 10 then stops the process to detect whether the input/output device is used in a reference period for 60 seconds (S540). That is, the information processing apparatus 10 detects approximately every 60 seconds whether or not the input/output device has been used in a reference period.

The detection means 200 detects whether or not the input/output device has been used (S550). If it has been used (S550: YES), the detection means proceeds to S580. Otherwise (S550: NO), the detection means 200 determines whether or not the reference period of time has elapsed (S560). That is, the detection means 200 determines whether or not the infrared communication device 60 or the keyboard illumination light 70 has been used in the reference period of time. If the reference period of time has been expired, that is, the input/output device has not been used within the reference period of time (S560: YES), the notification means 210 displays a help panel in order to notify the user that the infrared communication device 60 or the keyboard illumination light 70 is available (S570).

Furthermore, the notification means 210 may notify the user that the infrared communication device 60 is available, on the further condition that another input/output device that exchanges data with another input/output device is being used. For example, the notification means 210 may notify the user, on the further condition that a removable recording medium or a communication port is being used. In particular, the notification means 210 may notify this on the further condition that a memory card slot or USB (Universal Serial Bus)-connection-based memory key is being used or communication is being performed through a USB port. In addition to or instead of this, the notification means 210 may notify the user that the infrared communication device 60 is available, on the condition that it detects another apparatus capable of communicating through the infrared communication device 60. This allows the user to be notified that the infrared communication device 60 is available, only if the user is likely to use the infrared communication device 60.

Furthermore, the notification means 210 may notify the user that the keyboard illumination light 70 is available, on the further condition that the information processing apparatus 10 is being used in a predetermined period in the night. This allows the user to know that the keyboard illumination light 70 is available, only the period in which the user is likely to use the keyboard illumination light 70. The notification means 210 may display a help panel upon turning on the keyboard illumination light 70. This can notify the user more effectively that the keyboard illumination light 70 is available.

Then, if a further determination is required as to whether the input/output device has been used (S580: YES), the information processing apparatus 10 adjusts the reference period (S590), then returns to S510. For example, if the user is notified that the input/output device is available and yet does not use the input/output device, the information processing apparatus 10 adjusts the reference period appropriately so that the user is notified of the availability of the input/output device at regular intervals. Then the information processing apparatus 10 returns to S510.

On the other hand, if no further determination is required as to whether the input/output device has been used (S580: NO), the information processing apparatus 10 will end this process. For example, if the input/output device has been used, the information processing apparatus 10 will end this process and will not notify the user of the availability of the input/output device.

As has been described with respect to the above embodiments, the information processing apparatus 10 can detect an input/output device or power management function whose settings have not been changed within a reference period of time and notify a user that the user can change the settings. Furthermore, the information processing apparatus 10 can detect an input/output device that has not been used in a reference period of time and notify a user that the input/output device is available. This prompts the user to use various functions of the information processing apparatus 10, and consequently the convenience to the user can be enhanced.

While the present invention has been described with respect to embodiments thereof, the technical scope of the present invention is not limited to the specifics described with respect to those embodiments. It will be apparent to those skilled in the art that various changes or modifications can be made to the embodiments. It will be apparent from the claims that embodiments including those changes and modifications are also included in the technical scope of the present invention. For example, the information processing apparatus 10 may be a PDA (Personal Digital Assistant), which is smaller than a notebook personal computer, or may be a car navigation system or car audio system installed in a vehicle, or a home electric appliance.

An embodiment of the present invention may be provided as a method in which a service provider deploys computing infrastructure and program product in combination such that, once deployed, the combination performs a process according to any of the embodiments of the present invention.

In the drawings and specifications there has been set forth a preferred embodiment of the invention and, although specific terms are used, the description thus given uses terminology in a generic and descriptive sense only and not for purposes of limitation.

1. A product comprising:
a computer usable medium having computer readable program code stored therein for assisting a user in operating an information processing apparatus, the computer readable program code comprising:
detection code for detecting whether or not a setting on an input/output device of said information processing apparatus has been changed in a predetermined reference period; and
notification code for notifying said user that said setting on said input/output device is allowed to be changed, if said setting on said input/output device has not been changed in said reference period.

2. The product of claim 1, wherein said notification code activates a setting change program for accepting a change of said setting of said input/output device from said user if the setting of said input/output device has not been changed in said reference period.

3. The product of claim 1, wherein
said detection code detects whether or not the sensitivity of a pointing device of said information processing apparatus has been changed in said reference period, said sensitivity representing the distance a pointer moves when said pointing device is moved by a given amount; and
said notification code notifies said user that the sensitivity of said pointing device is allowed to be changed, if said setting of said pointing device has not been changed in said reference period.

4. The product of claim 1, wherein
said information processing apparatus has a function of, at a direction of the user, setting a response speed representing a time required for said information processing apparatus to recognize depression of a key on a keyboard after the key is pressed;
said detection code detects whether or not the response speed of any of keys on the keyboard of said information processing apparatus has been changed in the reference period; and
if the setting of said response speed has not been changed in said reference period and said notification code detects an erroneous typing of said key on said keyboard, said notification code notifies said user that the response speed of each key on said keyboard is allowed to be changed.

5. The product of claim 4, wherein if said response speed has not been changed in said reference period and a first key on said keyboard and a second key adjacent to said first key are depressed respectively within a predetermined period, said notification code detects said erroneous typing of said key on said keyboard and notifies said user that the response speed of any of the keys on said keyboard is allowed to be changed.

6. The product of claim 1, wherein said notification code notifies said user that the setting of said input/output device is allowed to be changed when said input/output device is being used by said user, on the condition that the setting of said input/output device has not been changed in said reference period.

7. The product of claim 1, wherein, if the setting of said input/output device has been changed by said user, said notification code does not notifies the user that the setting of said input/output device is allowed to be changed, and if the setting of said input/output device has not been changed by said user, said notification code notifies said user periodically that the setting of said input/output device is allowed to be changed.

8. The product of claim 1, wherein said detection code detects, for each combination of a particular user and a particular input/output device, whether or not a setting of the particular input/output device has been changed by the particular user in a reference period; and
said notification code, for each combination of the particular user and the particular input/output device, notifies that the setting of the particular input/output device is allowed to be changed if the particular input/output device has not changed by the particular user in said reference period.

9. A product comprising:
a computer usable medium having computer readable program code stored therein for assisting a user in operating an information processing apparatus, the computer readable program code including:
detecting code for detecting whether or not an input/output device of said information processing apparatus has been used in a predetermined reference period; and
notification code for notifying said user that said input/output device can be used, if said input/output device has not been used in said reference period.

10. The product of claim 9, wherein
said detection code detects whether or not a keyboard illumination light illuminating the keyboard of said information processing apparatus has been used in said reference period; and
said notification code notifies said user that said keyboard illumination light is available, if said keyboard illumination light has not been used in said reference period.

11. The product of claim 9, wherein
said information processing apparatus comprises a infrared communication device for communicating with another information processing apparatus by infrared rays;
said detection code detects whether or not said infrared communication device has been used in said reference period; and
said notification code notifies said user that said infrared communication device is available, if said infrared communication device- has not been used in said reference period.

12. A product comprising:
a computer usable medium having computer readable program code stored therein for assisting a user in operating an information processing apparatus, the computer readable program code including:
detection code for detecting whether or not a setting of power control function for controlling a power supply in said information processing apparatus has been changed in a predetermined reference period; and
notification code for notifying said user that the setting of said power control function is allowed to be changed, if the setting of said power control function has not been changed in said reference period.

13. The product of claim 12, wherein
said information processing apparatus has a hibernation mode in which a power consumption is lower than in a normal operation mode, a central processing unit of said information processing apparatus is stopped, and an execution state in which the central processing unit is executing an instruction is stored in an auxiliary storage device;
said detection code detects whether or not a setting of enabling or disabling a function of placing said information processing apparatus in said hibernation mode has been changed in said reference period; and
said notification code notifies said user that the function of placing said information processing apparatus in said hibernation mode is allowed to be enabled, if said function of placing said information processing apparatus in said hibernation mode has been kept disabled in said reference period.

14. The product of claim 13, wherein said information processing apparatus has suspend mode in which a power consumption is lower than in the normal operation mode but higher than in the hibernation mode and said central processing unit is stopped with the operation state of the central processing unit stored in a main memory; and
said notification code notifies said user that the function of placing said information processing apparatus in said hibernation mode is allowed to be enabled, on the condition that a time between the information processing apparatus switching from the normal operation mode to said suspend mode and returning to the normal operation mode is longer than a predetermined period.

15. The product of claim 12, wherein
said information processing apparatus has an input section that receives an input from said user, a display section that are provided to be able to open and close with said input section presents information to said user when said display section is at an open position and hides said input section from said user when said display section is at a close position, and a function of setting a plurality of different operation modes having different power consumption levels;
said detection code detects whether or not the operation mode in which said information processing apparatus is to be placed when said input section is closed in a normal operation mode has been changed in said reference period; and
said notification mode notifies said user that the operation mode in which said information processing apparatus is to be placed when said input section is closed is allowed to be changed, if said operation mode in which said information processing apparatus is, to be placed has not been changed in said reference period.

16. A method comprising:
deploying computing infrastructure by integrating computer readable code into a computer system, wherein the code in combination with the computing system is capable of performing the following:
detecting whether or not a setting on an input/output device of the computer system has been changed in a predetermined reference period; and
notifying the user that the setting on the input/output device is allowed to be changed, if the setting on the input/output device has not been changed in the reference period.

17. A method comprising:
deploying computing infrastructure by integrating computer readable code into a computer system, wherein the code in combination with the computing system is capable of performing the following:
detecting whether or not a setting of power control function for controlling a power supply in the information processing apparatus has been changed in a predetermined reference period; and
notifying the user that the setting of the power control function is allowed to be changed, if the setting of the power control function has not been changed in the reference period.

18. An information processing apparatus for assisting a user to operate the information processing apparatus, comprising:
a detector which detects whether or not a setting on an input/output device of said information processing apparatus has been changed in a predetermined reference period; and
a notifier which notifies the user that the setting on the input/output device is allowed to be changed, if the setting on the input/output device has not been changed in the reference period.

19. An information processing apparatus for assisting a user to operate the information processing apparatus, comprising:
a detector which detects whether or not an input/output device of the information processing apparatus has been used in a predetermined reference period; and
a notifier which notifies the user that the input/output device can be used, if the input/output device has not been used in the reference period.

20. An information processing apparatus for assisting a user to operate the information processing apparatus, comprising:
a detector which detects whether or not a setting of power control function for controlling power supply in the information processing apparatus has been changed in a predetermined reference period; and
a notifier which notifies the user that the setting of the power control function is allowed to be changed, if the setting of the power control function has not been changed in the reference period.
